(19) United States
(12) Patent Application Publication
(10) Pub. No.: US 2003/0134601 A1
(43) Pub. Date: Jul. 17, 2003

(54) Active antenna for communications transceiver

(76) Inventor: Chewnpu Jou, Hsinchu Hsien (TW)

Correspondence Address: J.C. Patents, Inc., Suite 250, 4 Venture, Irvine, CA, 92618, US

(21) Appl. No.: 10/047,648

(22) Filed: Jan. 14, 2002

(51) Int. Cl. H04B 1/46

(52) U.S. Cl. 455/82; 455/78; 455/73

(57) ABSTRACT

A communications device for transmitting RF signals from an external antenna. The device comprises a transceiver that sends signals over a cable to an external active antenna. In one embodiment the signals transmitted over the cable intermediate RF frequency signals. The active antenna receives the intermediate RF signals over the cable and up converts or down converts the respective RF transmit and receive signals. In another embodiment of the invention the signals transmitted over the cable are digital signals. The active antenna is functional to process, and covert the respective RF transmit and receive signals.

### BACKGROUND OF INVENTION

1. Field of the Invention

The present invention relates to an active antenna for a communications transceiver, more particularly, the invention relates to

2. Description of Related Art

Wireless communication devices are becoming increasingly popular allowing easier mobility, and not requiring cumbersome connecting cables. This is particularly so in the modern electronic work place where computers and other electronic devices can be linked together utilizing various topologies and different types of networks including advanced peer-to-peer networks (APPN), local area networks (LAN), cellular, PCS, Internet, and TCP/IP or various other types of networks. A radio frequency (RF) wireless communications device provides access such that the data processing terminal may be coupled to a large network utilizing RF communications technology. Thus, an operator utilizing such a computer may initiate communications and transfer data between his or her computer and a distributed data processing system without the necessity of access to either telephone lines or power lines. However, this increasing utilization of portable electronic devices refitted with communications modules has led to problems with the efficiency of radio frequency communication. Communication modules originally designed for use in cellular communications circuitry are typically constructed with internal antenna elements optimized for cellular communications. When used in laptops computers, or palmtop computers, RF interferences or non-ideal reception are often problems because of the noise, interference, obstruction and shielding caused by the various components of the devices. In particular, conventional antennas do not function correctly if they are obstructed or shielded by the housing or other structures of the computer. Therefore, one solution is to utilize external antennas.

FIG. 1 shows a conventional transceiver configuration. A transceiver 10 is connected to an radio frequency (RF) cable 11. The RF cable 11 transfers RF signals to and from the transceiver 10 to the antenna 12. However, with higher frequencies, the RF cable 11 is increasingly lossy, and its loss directly degrades system performance including sensitivity, transmission range, and hence power consumption. This loss also limits the distance the antenna 12 can be placed from the transceiver 10. Further high frequency-low loss cables and accompanying connectors are extremely cost prohibitive.

FIG. 2 shows a conventional active antenna module. A transceiver 20 is connected to an RF cable 21. The antenna module 24 consists of an antenna 22 connected to a low noise amplifier (LNA) 23. The antenna module 24 is connected to the other end of the RF cable 21. The advantage using a LNA 23 is that it allows the antenna module 24 to be placed far away from the transceiver 20. However, if a high RF frequency is used, the cost of the RF cable 21 is cost prohibitive. Further, if the antenna module 24 is placed a large distance from the transceiver 20, a significant transmit signal power loss occurs.

FIG. 3 shows a conventional active antenna 40. A transceiver 30 is connected by an extension RF cable 31 to an active antenna 40. The active antenna 40 includes a first duplexer 41, a low noise amplifier (LNA) 42, a power amplifier (PA) 43, a second duplexer 44, and an antenna 45. Signals are transmitted from the transceiver 30 through the extension RF cable 31 to the active antenna 40. The first duplexer 41 separates transmitted and received signals based on their frequency difference. A transmitted signal is then amplified by the PA 43 and outputted to the antenna 45. A received signal through the antenna 45 passes to the second duplexer 44 that separates transmitted and received signals based on their frequency, and then passes a receive signal to the LNA 42 for amplification. The signal then passes through the extension RF cable 31 to the transceiver 30. The active antenna 40 allows a transceiver antenna to be placed a greater distance from the transceiver 30 than the extension RF cable loss normally allows. However, since the frequencies transmitted over the extension RF cable 31 can be a high frequency, the desired extension RF cable 31 is very expensive. Furthermore, the duplexers 41 and 44 cannot be easily reconfigured to variations in transmitting and receiving frequencies and the duplexers 41 and 44 are extremely costly.

Therefore, a need exists for a communications antenna apparatus that does not require an expensive RF cable, duplexers, or is distance prohibitive.

### SUMMARY OF THE INVENTION

One aspect of the invention is an antenna for a radio frequency (RF) communications system.

Another aspect of the invention is to provide an antenna for a RF communication system that eliminates the need for expensive RF cable to connect the RF transceiver and an antenna.

A communications receiver is connected to an active antenna module. A main feature of the invention is the transmission of low frequency signals over a low cost cable, wherein the active antenna module is functional to up convert a transmit frequency for transmission, and a received frequency is down converted for transmission over the connecting cable.

In one embodiment of the invention a transceiver transmits RF signals at a low intermediate frequency (IF), along with control words, and a DC power supply over a extension IF cable connecting an active antenna module. The control words control switches in the antenna module that connect transmit and receive circuitry to the antenna and IF cable input at specific transmit/receive time periods as specified by a communications protocol. The control word further controls the frequency of a synthesizer in the antenna module. When a transmission signal passes through the IF cable from the transceiver, it passes though a first switching device to a mixer. The signal is then up converted when mixed with a signal from an oscillator and the synthesizer. The up-converted signal is then amplified and passes through a second switching device before going to an antenna. When a signal is received by the antenna is passes through the second switching device to a low noise amplifier. The signal then passes to a mixer where it is down-converted when mixed with a signal from the oscillator/synthesizer. The down-converted received signal then passes through the first switching device and travels via the extension IF cable to the transceiver.

In a second embodiment of the invention a communications unit is connected to an active antenna module through an extension cable. A transceiver sends digital data containing transmission information to a data framer. Likewise a control word generator sends digital information to the data framer. The data framer packages the information and transmits the data along with a D.C. power supply though an extension cable to active antenna module. A data framer in the antenna module separates the information. The control word data controls the frequency of a synthesizer and a switch functional to connect to transmit/receive circuitry at specific time periods as specified by a communications protocol. Transmit information from the transceiver passes through a digital signal processor, to an digital to analog converter, and then to an mixer where the signal is up converted when mixed with a frequency generated by the frequency synthesizer/oscillator. The signal is then amplified by a power amplifier, and passes through a switch to an antenna. When a signal is received it passes through a low noise amplifier, is down converted by a mixer with a frequency generated from the synthesizer/oscillator. The signal then passes through an intermediate frequency signal processor, to an analog to digital converter, and to a digital signal processor. The data then passes to the antenna module data framer, passes through the extension cable, to the second data framer, and then to the transceiver.

These and other features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF DRAWINGS

FIG. 1 shows a conventional external antenna;

FIG. 2 shows another conventional active antenna;

FIG. 3 shows another conventional active antenna;

FIG. 4 shows a communications module of a first embodiment

FIG. 5 shows a communication module; and

FIG. 6 shows a third embodiment of a communication module.

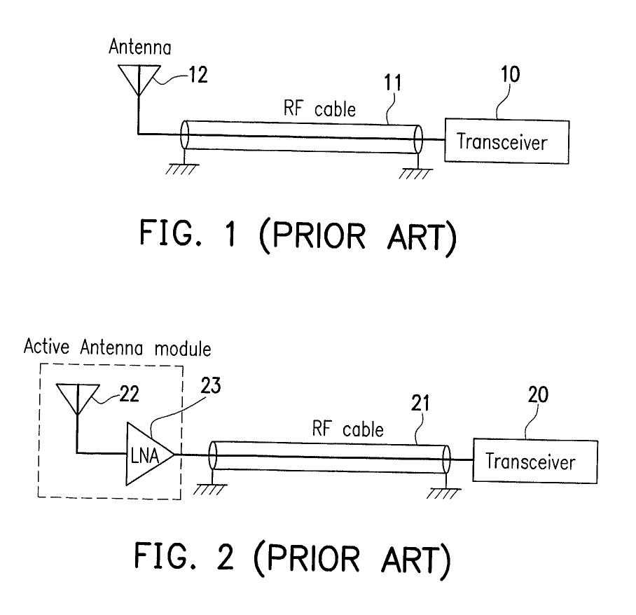

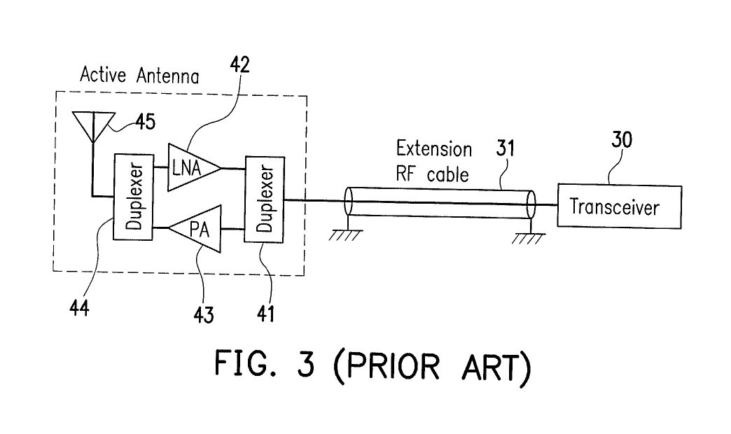

### DETAILED DESCRIPTION OF PREFERRED EMBODIMENTS

In the following detailed description of the preferred embodiments, reference is made to the accompanying drawings that form a part hereof, and in which is shown by way of illustration specific preferred embodiments in which the invention may be practiced. The preferred embodiments are described in sufficient detail to enable these skilled in the art to practice the invention, and it is to be understood that other embodiments may be utilized and that logical, changes may be made without departing from the spirit and scope of the present invention. The following detailed description is, therefore, not to be taken in a limiting sense, and the scope of the present invention is defined only be the appended claims.

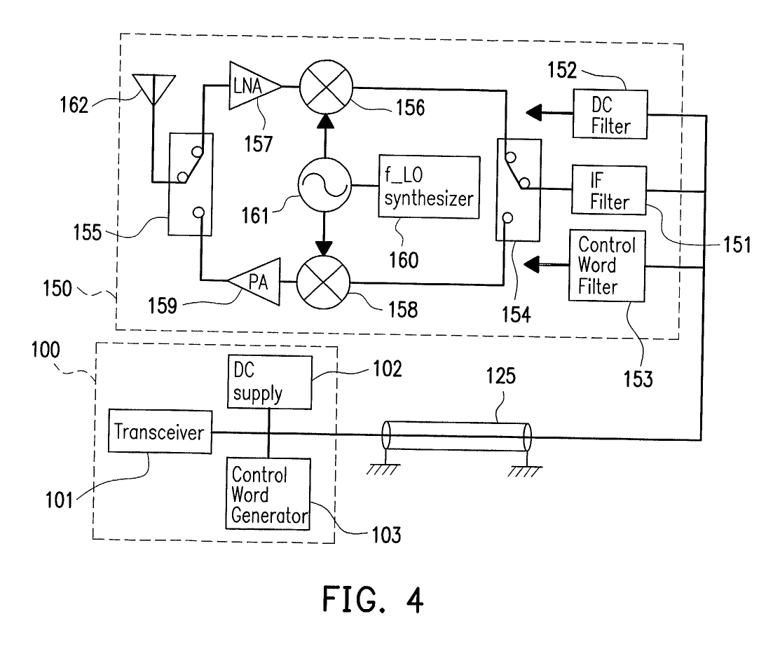

In a first embodiment of the invention as shown in FIG. 4, an extension intermediate frequency (IF) cable 125 connects a communications unit 100 to an active antenna module 150. The extension IF cable 125 in the embodiment is preferably a multi-strand cable for carrying the signals. The communications unit 100 includes a transceiver 101, a DC supply source 102, and a control word generator 103. The active antenna module 150 includes an intermediate frequency (IF) filter 151, a control word filter 153, and a DC filter 152. The IF filter 151 is connected to a switch 154. The switch 154 is connected to a receiving mixer 156 and a transmitting mixer 158. A low noise amplifier (LNA) 157 is disposed between the receiving mixer 156 and a switch 155. A power amplifier 159 is disposed between the transmitting mixer 158 and the switch 155. The transmitting mixer 158 and the receiving mixer 156 are connected to a low-frequency f_LO synthesizer 160 and oscillator 161. The input of the LNA 157 and output of the PA 159 are connected to an antenna 162 alternatively through the antenna switch 155.

The DC supply 102 provides electrical power for the operation of the active antenna module 150, and the DC filter 152 is provided in the active antenna module 150 to reduce any fluctuation in the DC supply 102 that occurs during transmission over the extension IF cable 125. A control word generator 103 generates control signals for the switch 154, the switch 155 and the f_LO synthesizer 160. The control word filter 153 is operable to receive signals transmitted from the control word generator 103 over the extension IF cable 125, and provide the signals to the appropriate device, such as the switch 154, the switch 155 and the f_LO synthesizer 160. For example, in an event of a transmission of data in the system, the transceiver 101 transmits data in a proper time slot over the extension IF cable 125 along with the appropriate control words from the control word generator 103, and DC power to operate the active antenna module 150. The control word creates a connection path to be made between the IF filter 151, the transmitting mixer 158 and the PA 159 with the antenna 162. The control word also instructs the f_LO synthesizer 160 to generate a proper frequency. The data is passed through the IF filter 151, the switch 154 to the transmitting mixer 158. After the transmitted data being mixed with a frequency generated by the oscillator 161, a higher frequency signal will be amplified by the PA 159 and outputted through the antenna 162.

When data is received in the appropriate time slot, the control work generator 103 configures the switches 155 and 154 to make a connection between the antenna 162 and the input of the LNA 157, and the output of the mixer 156 and the IF filter 151. The control word further sets the frequency generated by the f_LO synthesizer 160. The data is received by the antenna 162 and amplified by the low noise amplifier 157. The signal then enters the mixer 156 with the frequency from the oscillator 161 lowering the frequency of the signal. The signal then passes through the IF filter 151, the extension IF cable 125, to the input of the transceiver 101.

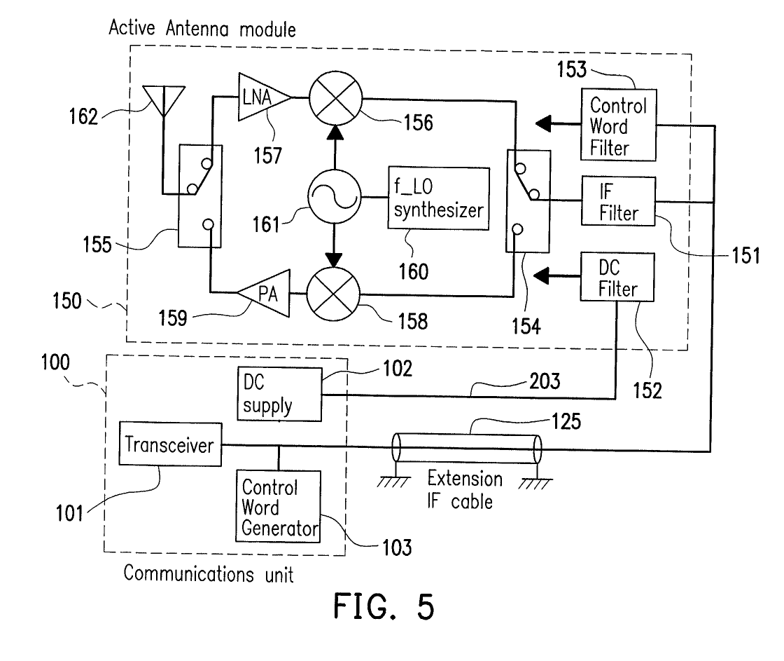

FIG. 5 shows an embodiment of the invention similar in every way to the apparatus shown in FIG. 4, however the DC supply is provided on a line separate from the Extension IF cable 203 to the DC filter 215 of the active antenna module. That is, an additional line for supplying power is provided in the embodiment.

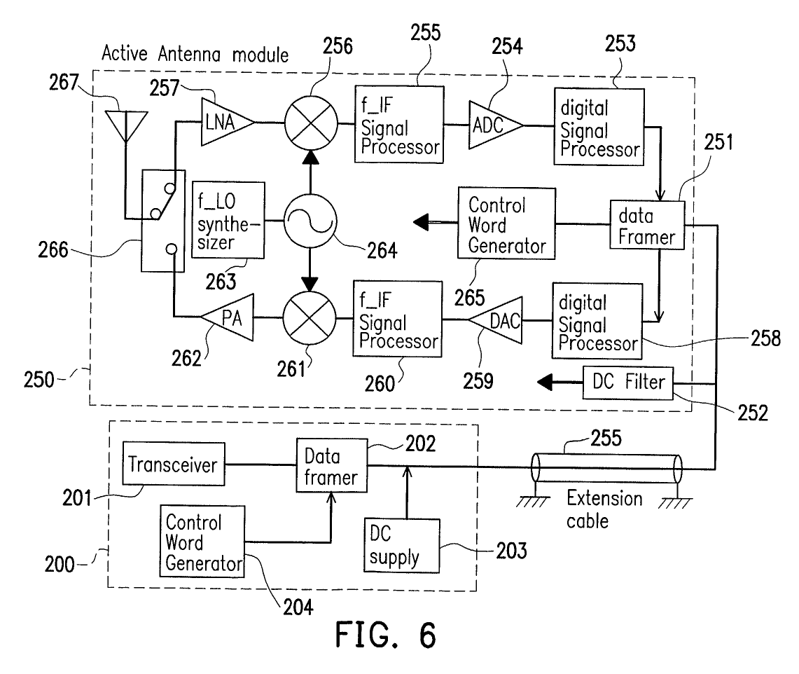

FIG. 6 shows another embodiment of the invention. An extension IF cable 225 connects a communications unit 200 with an active antenna module 250. A data framer 202 is connected to a transceiver 201 and a control word generator 204. The data framer 202 and a DC supply source 203 are connected to an extension IF cable 225. In the active antenna module 250 another data framer 251 and a DC filter 252 are connected to the extension IF cable 225. The data framer 251 is connected to a control word filter 265. A data-out portion of the second data framer 251 is connected to a digital signal processor 258, a digital to analog converter (DAC) 259, a f_IF signal processor, a mixer 261, and then a power amplifier 262. A receiving portion of the data framer is connected to a digital signal processor 253, an analog to digital converter (ADC) 254, a f_IF signal processor 255, a second mixer 256, and a low noise amplifier 257. The mixers 261 and 256 are connected to a f_LO synthesizer 263 and an oscillator 264. The input of the LNA 257 and the output of the PA 262 are connected to a switch 266 and an antenna 267.

When a data transmission occurs data from the transmitter 201 is sent to the data framer 202, along with appropriate control words from the control word generator 204. The data framer 202 packages the digital data into a data format that can be transmitted over the extension IF cable 225 preferably over a single cable strand. In addition, a DC supply 203 is transmitted over the extension cable to supply the active antenna module 250 with power. The data framer 251 of the active antenna module receives the transmit data along with the control words. The control words pass to the control word filter, and then are used to control elements of the active antenna module 250 such as the frequency generated by the f_LO synthesizer, and the switch 266. The control words can be further utilized to control the signal processors of the active antenna module 250. The transmitted digital data is then outputted from the data framer 251 to the digital signal processor 258. The digital signal processor 258 processes the data and then sends the digital data to the DAC 259. The outputted analog signal is then passed to the f_IF signal processor for further processor before being mixed with a frequency from the oscillator 264 up-converting the frequency of the signal. The signal is then amplified by the PA 262, passes through the switch 266 and is outputted from the antenna 267.

Signals received by the antenna 267 pass through the switch 266 to the LNA 257. The amplified signal is then mixed with a signal from the oscillator 264 in the mixer 256 down-converting the frequency of the signal. The down-converted signal is then processed by the f_IF signal processor 255 and is converted to digital signal in the ADC 254. The digital received signal is processed by the digital signal processor 253 and is passed to the data framer 251. The data framer packages the received data and transmits it over the extension cable 225. The data framer 202 in the communications unit 200 retrieves the received digital data and forwards it to the transceiver 201.

Various additional modifications may be made to the illustrated embodiments without departing from the spirit and scope of the invention. Therefore, the invention lies in the claims hereinafter appended.

What is claimed:

1. A communications module comprising:
a transceiver for transmitting and receiving intermediate frequency RF communication signals;
an external active antenna functional to receive and transmit the intermediate frequency RF communication signals, up-convert and down-convert the respective signals, and receive and transmit the higher frequency RF signals from an antenna; and
a cable for conveying intermediate frequency communications signals between the transceiver and the external antenna;

2. The communications module of claim 1, further comprising:
a power supply over the cable for supplying the active antenna with power.

3. The communications module of claim 1, wherein control words are further generated and transmitted through the cable to the active antenna.

4. The communications module of claim 3, wherein the active antenna further comprising:
a first switch controlled by a control word for connecting a transmission cable input with the transmit or receive circuitry of the antenna module;
a frequency synthesizer;
a first mixer for up converting a transmit signal;
a power amplifier for amplifying a transmit signal;
a second mixer for down converting a received signal;
a low noise amplifier for amplifying a received signal;
a second switch for controlled by a control word for connecting the input of the low noise amplifier, or the output of the power amplifier to an antenna; and
an antenna for transmitting and receiving signals.

5. The communications module of claim 3, further comprising:
a control word generator for generating and transmitting control words over the cable.

6. A communications module comprising:
a transceiver for transmitting and receiving digital communication signals;
an external active antenna functional to receive and transmit the digital communication signals, process and convert digital signals to RF signals, and process and convert RF signals to digital signals, and receive and transmit the RF signals from an antenna; and
a cable for conveying the digital signals between the transceiver and the external antenna.

7. The communications module of claim 6 further comprising:
a control word generator for generating control words;
a data framer connected to the transceiver and control word generator, functional to package the data and transmit the packaged data over the extension cable;

8. The communications module of claim 6, wherein the active antenna further comprising:
a data framer for receiving and transmitting packaged data over the extension cable;
a first digital signal processor for processing received transmit digital data;
a digital to analog converter to convert the digital data from the first digital signal processor into a transmit intermediate frequency signal;
a first IF signal processor for processing the transmit intermediate frequency signal;
a first mixer for mixing the transmit intermediate frequency signal and a signal from a frequency synthesizer to up convert the transmit signal
a power amplifier for amplifying the up converted transmit signal
a low noise amplifier for amplifying a received signal from an antenna;
a second mixer for mixing the received signal and a signal from the frequency synthesizer to down convert the received signal to an received intermediate frequency signal;
a second IF signal processor for processing the received intermediate frequency signal;
an analog to digital converter for converting the received intermediate frequency signal to a received digital signal;
a receive digital signal processor for processing the received digital signal; and
a second switch for connecting the output of the power amplifier, and the input of a low noise amplifier with an antenna.

9. The communications module of claim 7, further comprising a DC power supply for supplying power to the active antenna over the extension cable;
